(19) United States
(12) Patent Application Publication
(10) Pub. No.: US 2009/0056863 A1
(43) Pub. Date: Mar. 5, 2009

(54) Method for making color changeable decorative material

(76) Inventor: Ting Tung Lin, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/290,297

(22) Filed: Oct. 29, 2008

Related U.S. Application Data
(63) Continuation-in-part of application No. 11/349,396, filed on Feb. 7, 2006.

(51) Int. Cl. B32B 38/10

(52) U.S. Cl. 156/230

(57) ABSTRACT

A method for making a decorative material includes preparing a bearing sheet, mixing powders and golden oil together to form a mixed material, applying the mixed material onto the bearing sheet for forming a pattern on the bearing sheet, the pattern formed by the powders and the golden oil is capable of reflecting colors and is color changeable when seen from different angles. A releasing layer may sandwich the pattern between the bearing sheet and the releasing layer. The bearing sheet will be removed from the releasing layer for leaving the pattern on the releasing layer, and the releasing layer and the pattern will be immersed in a fluid, for allowing the pattern to be attached onto an object.

This application is a Continuation in Part (CIP) of previously U.S. application Ser. No. 11/349,396, and claims the priority of the filing date of Feb. 7, 2006, and Claims 1-3 in the current CIP application correspond to Claims 1-3 in the parent application, respectively, and are entitled to the parent application's filing date of Feb. 7, 2006.

### BACKGROUND OF THE INVENTION

### Field of the Invention

### Description of the Prior Art

Typical decorative materials comprise a backing material having a surface for contacting or bearing a resinous sheet and for being coated with a copolymer of vinyl chloride and vinylidine chloride, or the like, and the opposite, unadhered surface of the resinous sheet may be printed with patterns.

For example, U.S. Pat. No. 3,549,482 to Okutani discloses a typical printing material and process for producing the same, and for providing a printed label from a vinyl or vinylidine chloride polymer having a high plasticizer content, for example, the printed label is made from a resinous sheet containing 100 parts by weight of polyvinyl chloride or polyvinylidene chloride and an amount of greater than 50 parts by weight of a plasticizer, and the label is printed by means of five color offset printing to produce a printed label.

However, the printed materials normally include a single color and the color or the patterns of the printed materials may not be reflected or changed when the printed labels are seen from different angles.

The present invention has arisen to mitigate and/or obviate the afore-described disadvantages of the conventional methods for making printing or decorative materials.

### SUMMARY OF THE INVENTION

The primary objective of the present invention is to provide a method for making a decorative material having color changeable or reflective characteristics for forming color changeable patterns and for allowing the users to see colorful patterns.

In accordance with one aspect of the invention, there is provided a method for making a decorative material comprising preparing a bearing sheet, mixing powders and golden oil together to form a mixed material, applying the mixed material onto the bearing sheet for forming a pattern on the bearing sheet, the pattern formed by the powders and the golden oil being capable of reflecting colors and being color changeable when seen from different angles, attaching a releasing layer onto the pattern and the bearing sheet for sandwiching the pattern between the bearing sheet and the releasing layer, removing the bearing sheet from the releasing layer for allowing the pattern to be provided and left on the releasing layer, and immersing the releasing layer and the pattern into a fluid, for allowing the pattern to be attached onto an object.

It is preferable that the powders include 5% by weight, and the golden oil 95% by weight, before mixing the powders and the golden oil together for allowing the powders to reflect colors or to generate colorful images.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating the processes for conducting a method in accordance with the present invention;

FIG. 2 is an exploded view of a decorative material made with the method of the invention;

FIG. 3 is a plan schematic view of the decorative material; and

FIG. 4 is a perspective view of the decorative material.

### DETAILED DESCRIPTION OF THE PREFERRED EMBODIMENTS

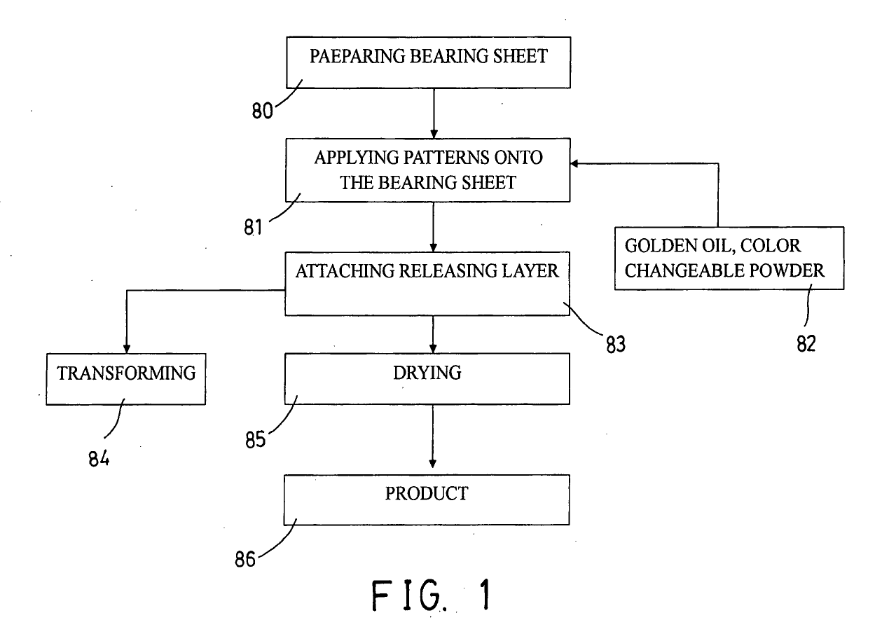

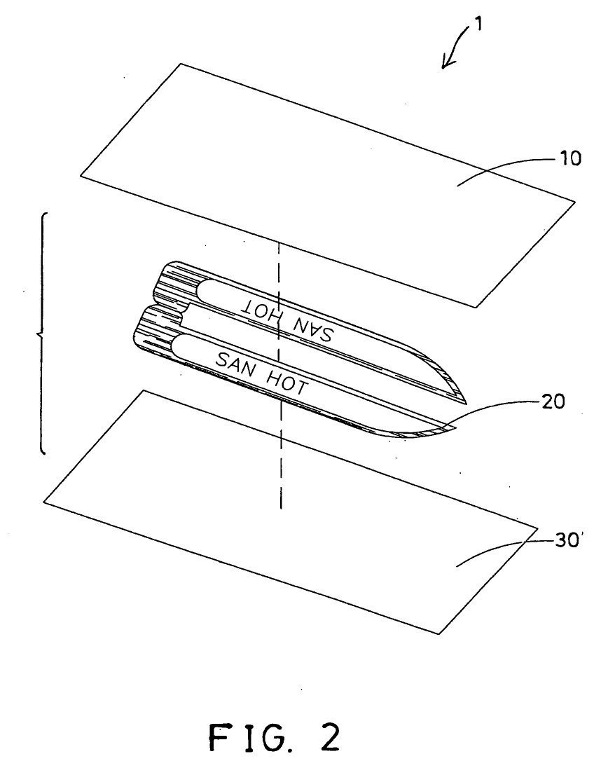

Referring to the drawings, and initially to FIGS. 1 and 2, a method in accordance with the present invention is provided for making a decorative material 1 having color changeable or reflective characteristics for forming color changeable patterns and for allowing the users to see colorful patterns.

For example, the decorative material 1 comprises a bearing sheet 10 made or resin materials or various synthetic materials having an oily or greasy layer (not shown and not labeled) provided or applied thereon, and the method in accordance with the present invention is first required to prepare one of the bearing sheet 10 in the process 80 as shown in FIG. 1.

A pattern 20 is then applied onto the bearing sheet 10 in the process 81 as shown in FIG. 1, such as painted or printed or transformed onto the oily or greasy layer of the bearing sheet 10 for preventing the pattern 20 from being solidly or firmly stuck or adhered or secured onto the bearing sheet 10, but for allowing the pattern 20 to be temporary or detachably or releasably secured onto the bearing sheet 10 after a curing or drying or aging process.

As also shown in FIG. 1, the materials 82 for forming the pattern 20 include colorful or color changeable particles or powders, such as pearl powders having about 5% by weight or by volume, and golden oil having about 95% by weight or by volume, and the powders and the golden oil are then mixed or blended together for forming a sticky or pasty material that may then be painted or printed or transformed onto the oily or greasy layer of the bearing sheet 10 for forming the pattern 20. The materials 82 including the colorful or color changeable particles or powders and the golden oil are required to be mixed or blended together, before the process 81, for forming a mixed material that may then be applied onto the bearing sheet 10 to form the pattern 20. It is to be noted that the golden oil consists of oil-based resin which is made by mixing drying oil, modified resin and driers together or mixing semi-drying oil, modified resin and driers together, wherein the drying oil is tung oil or flax seed oil, and the semi-drying oil is soybean oil, rice bran oil, or tall oil. The modified resin is slightly added and mixed with the drying oil according to the property of the golden oil. It is preferred that the golden oil consists of alkyd resin which is made by mixing driers. The driers consist of Naphthenic acid soaps and stearic acid soaps, and the Naphthenic acid soaps is made of cobalt, lead, and manganese.

The provision of the colorful or color changeable particles or powders and/or the golden oil in the material for forming the pattern 20 allows the color of the pattern 20 to be changeable or changed as seen from various or different angles, and/or allows the color of the pattern 20 to be gradually changed when the viewing angles are gradually changed.

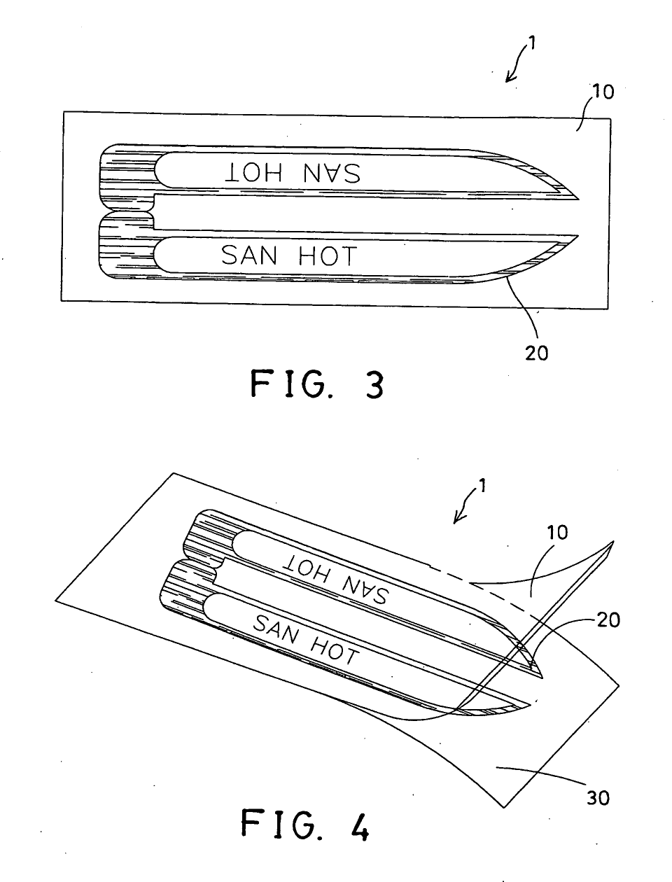

A releasing layer 30 is then attached or adhered onto the pattern 20 and the bearing sheet 10 and arranged for sandwiching the pattern 20 between the bearing sheet 10 and the releasing layer 30 in the process 83 as shown in FIG. 1, in order to form the decorative material 1 as shown in FIGS. 3 and 4.

When it is required to transform the pattern 20 onto the other objects, such as vehicles, bicycles, shoes, boots, porcelains, ceiling fans, computers, or other electrical products, suitcases, portable phones, etc. in the process 84 as shown in FIG. 1, the bearing sheet 10 is first peeled off or removed from the releasing layer 30 for allowing the pattern 20 to be provided and left on the releasing layer 30. The bearing sheet 10 may be suitably peeled off or removed from the releasing layer 30 due to the oily or greasy. layer of the bearing sheet 10.

The releasing layer 30 and the pattern 20 provided thereon are then immersed into water or selected solution or fluid, for allowing the pattern 20 to be stuck or adhered or secured onto the objects. The releasing layer 30 and the pattern 20 are then dried in such as an oven (not shown) in the process 85 as shown in FIG. 1, for allowing the pattern 20 to be solidly or firmly stuck or adhered or secured onto the objects, and also for allowing the releasing layer 30 to be disengaged or removed from the objects and the pattern 20, and thus for allowing the pattern 20 to be left and solidly or firmly stuck or adhered or secured onto the objects, as a product 86 as shown in FIG. 1.

It is to be noted that the provision or the mixing or blending of the colorful or color changeable particles or powders and/or the golden oil in the pattern 20 allows the pattern 20 to be seen as color changeable or changed from various or different angles, and/or allows the color of the pattern 20 to be gradually changed when the viewing angles are gradually changed.

It is further to be noted that in process 85, the releasing layer 30 and the pattern 20 are dried in such as an oven, but not dried with an iron or the like, such that the releasing layer 30 and the pattern 20 will not be scrubbed or deformed by other objects or by the iron, and the pattern 20 may be suitably stuck or adhered or secured onto the objects of various shapes or contours according to the shapes or contours of the objects.

The pattern 20 of different colors or figures may be formed or applied onto two or more areas of the objects for forming a spatial structure or spatial-like configuration, or for forming a contrast structure.

Accordingly, the method in accordance with the present invention may be provided for making a decorative material having color changeable or reflective characteristics for forming color changeable patterns and for allowing the users to see colorful patterns.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

What is claimed is:

1. A method for making a decorative material comprising: preparing a bearing sheet, mixing powders and golden oil together to form a mixed material, applying the mixed material onto the bearing sheet for forming a pattern on the bearing sheet, the pattern formed by the powders and the golden oil being capable of reflecting colors and being color changeable when seen from different angles, attaching a releasing layer onto the pattern and the bearing sheet for sandwiching the pattern between the bearing sheet and the releasing layer, removing the bearing sheet from the releasing layer for allowing the pattern to be provided and left on the releasing layer, and immersing the releasing layer and the pattern into a fluid, for allowing the pattern to be attached onto an object.

2. The method as claimed in claim 1 further comprising preparing 5% of the powders by weight, and preparing 95% of the golden oil by weight, before mixing the powders and the golden oil together.

3. The method as claimed in claim 1 further comprising drying the releasing layer and the pattern in an oven after the pattern is attached onto the object, for allowing the pattern to be secured onto the object, and for allowing the releasing layer to be removed from the object and the pattern.
